(19) United States
(12) Patent Application Publication
(10) Pub. No.: US 2010/0076839 A1
(43) Pub. Date: Mar. 25, 2010

(54) INTERNET ADVERTISEMENT SYSTEM AND METHOD BASED ON PROVISION OF CONTENT

(76) Inventors: Chan Goo Kang, Seoul (KR); Gwang Lim Ghim, Seoul (KR); Kyu Jin Shim, Geoje-si (KR)

Correspondence Address: CHRISTIE, PARKER & HALE, LLP, PO BOX 7068, PASADENA, CA, 91109-7068, US

(21) Appl. No.: 12/448,440

(22) PCT Filed: Dec. 21, 2007
(86) PCT No.: PCT/KR2007/006734

§ 371 Date: Nov. 25, 2009

(30) Foreign Application Priority Data
Dec. 22, 2006 (KR) 10-2006-0132368

(51) Int. Cl. G06Q 30/00

(52) U.S. Cl. 705/14.46; 705/14.49

(57) ABSTRACT

The present invention relates to a system and method based on provision of content. The system includes an operator server (100) for receiving content from a provider computer, receiving information about an advertisement website from an advertiser computer, and receiving a web page to which unique HTML code for content is attached, from a propagator computer, thus providing an advertisement corresponding to content that is used. The provider computer (200) transmits or receives content and information about payment conditions to or from the operator server (100). The advertiser computer (300) transmits or receives information about a website desired to be advertised and payment conditions to or from the operator server. The propagator computer (400) transmits or receives information about the web page of a propagator, HTML code, and payment conditions related to use of content by a typical Internet user to or from the operator server (100).

### TECHNICAL FIELD

The present invention relates, in general, to an Internet advertisement system and method for enticing Internet users to visit the website of an advertiser using content, and, more particularly, to an Internet advertisement system and method based on the provision of content, which attach unique

HTML code, assigned to each content item, to a desired web page, thus enabling an advertisement website including the content item to be displayed when an Internet user executes the HTML code.

### BACKGROUND ART

As well known to those skilled in the art, Internet advertisement methods are composed of two pipelined procedures. The first procedure is where the advertisement messages are exposed to users who visit websites to view content. For example, a method of exposing links and their text descriptions is used in case of search advertisements and graphic image exposure in case of display banner advertisements.

However, such a method is problematic in that it does not explicitly entice persons to visit advertisers' websites. Since persons know that such exposure is intended for advertisements, they visit websites only when they are interested in the displayed advertisement materials. In order to solve this problem, more inconspicuous advertisement techniques, such as Google AdSense service and Text-Link-Ads service, in which users are deceived into believing that an advertisement message is part of the actual contents of a website and into clicking a link to the advertisement message, has appeared. However, when the message is exposed using this method of pretending that it is not an advertisement, there is a problem that a visitor may resent the deception, which will cancel, and possibly reverse the advertising effect.

The second procedure is the act of enticing users into abandoning his or her originally intended work to visit the advertiser's website. For example, when a search is performed in a search engine website, such as Naver, an advertisement is exposed together with the results of the search. At this time, when a user clicks the advertisement to abandon the search results, the user escapes from his or her previous search work and pays attention to the particular advertiser's website. As another example, there is the case where a user may view a banner advertisement and may visit an advertisement website while viewing a news item provided by a portal service, and thus the continuity of the originally intended work and train of thought is easily lost. However, due to these problems, persons have a tendency not to click advertisement messages, other than an advertisement message of interest, in order to prevent interruptions in the use of the Internet. That is, there is a limitation in that an advertiser's brand can be sufficiently promoted only to persons who intentionally visit websites for the purpose of viewing the advertisement. Therefore, an attempt to advertise a brand without interfering with the work of persons has been made. As examples of this attempt, there are the cases where an advertiser users lurid descriptions to be shown in the search results, so as to draw website users' attention to visit the website, and where intrusive eye-catching effects are used to make the display banner stand out and draw attention of the website visitors.

These methods are used because advertising methods that are not intrusive enough lack their effects. However, when a lurid search advertisement phrase is inserted or an intrusive eye-catching banner advertisement is used so as to increase the advertising effect, the resentment of users increases instead, and thus the advertising effect is decreased, which is the opposite of what was intended.

### DISCLOSURE

### [Technical Problem]

Accordingly, the present invention has been made keeping in mind the above problems occurring in the prior art, and an object of the present invention is to provide an Internet advertisement system and method, which associate internet users' intention to consume particular contents with advertisement, thus enticing the users to visit advertiser's websites while accomplishing their original intention, which is to consume the content.

Another object of the present invention is to provide an Internet advertisement system and method, which allow advertisement websites to stay exposed without interfering with the use of content by Internet users.

A further object of the present invention is to provide an Internet advertisement system and method, in which a user attaches the reference to the content made by other persons to his or her web page, so that Internet users can be propagators for voluntarily propagating content, not to mention the advertisement that comes along with the content, and the propagators can generate revenue according to the degree of use of content by visitors who visit the propagator's page.

### [Technical Solution]

In order to accomplish the above objects, the present invention provides an Internet advertisement system based on provision of content, comprising an operator server for receiving content from a provider computer, information about an advertiser's website from an advertiser computer, and a web page, to which unique HyperText Markup Language (HTML) code for the content is attached, from a propagator computer, thus providing an advertisement corresponding to content that is used; the provider computer for transmitting or receiving the content and information about payment conditions to or from the operator server; the advertiser computer for transmitting or receiving information about a website desired to be advertised and payment conditions related to an advertisement to or from the operator server; and the propagator computer for transmitting or receiving information about the web page of a propagator, the HTML code, and payment conditions related to use of content by a typical Internet user to or from the operator server.

Preferably, the operator server may comprise a content management unit for receiving content from the provider computer, and storing and managing the content, a first content search unit for searching for content stored in the content management unit in response to a request from the advertiser computer, a second content search unit for searching for content stored in the content management unit in response to a request from the propagator computer, a user information management unit for receiving information about a provider, information about an advertiser, and information about the propagator from the provider computer, the advertiser computer, and the propagator computer, respectively, storing and managing the received information, receiving information about the advertiser's website from the advertiser computer and information about the propagator's web page from the propagator computer, and managing the website information and the web page information, a purchase information management unit for receiving information about an advertiser, who purchased content, from the advertiser computer, and separately storing and managing the advertiser information and the purchased content when the advertiser purchases the content, and a central processing unit for executing an entire process by controlling the content management unit, the first content search unit, the second content search unit, the user information management unit, and the purchase information management unit in a centrally controlled manner, the central processing unit comprising operating software for going to a web page of the advertisement system, separating a floating area and an advertisement background area in the web page of the advertisement system, and enabling given content to be used in the advertiser's website.

Preferably, the user information management unit may comprise a provider Database (DB) for receiving the provider information from the provider computer and managing the provider information, an advertiser DB for receiving the advertiser information and the information about the website desired to be advertised by the advertiser from the advertiser computer, and managing the advertiser information and the website information, and a propagator DB for receiving the propagator information and the information about the web page, to which unique HTML code for content selected by the propagator is attached, from the propagator computer, and storing and managing the propagator information and the web page information.

Preferably, the Internet advertisement system may comprise a payment unit for calculating a fee incurred for purchase of the content on a basis of the payment conditions.

Preferably, the content may have any one form of text, images, sound, moving images, games, and applications, and may be assigned a unique Identification (ID) and unique HTML code.

Further, the present invention provides an Internet advertisement method based on provision of content in a method of registering an advertisement and content using an Internet advertisement system based on provision of content, the Internet advertisement system including an operator server, a provider computer, an advertiser computer and a propagator computer, comprising the steps of (a) the operator server receiving information about a provider from the provider computer and storing the provider information; (b) the operator server receiving content from the provider computer and storing the content; (c) the operator server receiving information about an advertiser from the advertiser computer and storing the advertiser information; (d) the operator server providing the content to the advertiser computer, calculating a fee incurred for purchase of the content, and providing information about the fee to the advertiser computer in response to a request from the advertiser computer; and (e) the operator server storing the advertiser information and corresponding content when a corresponding content purchase signal is received from the advertiser computer.

Preferably, the Internet advertisement method may further comprise the step of (f), after step (e), the operator server being paid a fee, incurred for purchase of the content, by the advertiser computer.

In addition, the present invention provides an Internet advertisement method based on provision of content in a method of providing content using an Internet advertisement system based on provision of content, the Internet advertisement system including an operator server, a provider computer, an advertiser computer, and a propagator computer, comprising the steps of (g) the operator server receiving information about a propagator from the propagator computer and storing the propagator information; (h) the operator server searching for content in response to a request from the propagator computer and providing the content to the propagator computer; (i) the operator server receiving information about a web page, to which unique HTML code for content, selected by the propagator, is attached, from the propagator computer, and storing the web page information; (j) the operator server executing the HTML code for the content, providing content corresponding to the HTML code to a floating area, and exposing an advertiser's website to a background area when a content execution signal is received from a typical computer; and (k) the operator server calculating revenue obtained through execution of the HTML code on a basis of payment conditions.

Preferably, the Internet advertisement method may further comprise the step of (l), after step (k), the operator server calculating revenue and depositing the revenue to accounts of both a provider and the propagator.

### DESCRIPTION OF DRAWINGS

FIG. 1 is a diagram showing the construction of an Internet advertisement system based on the provision of content according to an embodiment of the present invention;

FIG. 2 is a conceptual diagram showing the configuration of a screen for the Internet advertisement system based on the provision of content according to an embodiment of the present invention;

FIG. 3 is a flowchart showing a process for registering content and advertisements according to an embodiment of the present invention;

FIG. 4 is a flowchart showing a process for receiving information about the web page of a propagator, to which unique HTML code for content is attached, and providing the content according to an embodiment of the present invention;

FIG. 5 is a diagram showing an example of implementation of an Internet advertisement method according to an embodiment of the present invention;

FIG. 6 is a diagram showing an example of implementation of an Internet advertisement method according to another embodiment of the present invention; and

FIG. 7 is a diagram showing an example of implementation of an Internet advertisement method according to a further embodiment of the present invention.

### DESCRIPTION OF REFERENCE CHARACTERS OF PRINCIPAL ELEMENTS IN THE DRAWINGS

100: operator server 110: content management unit

120: first content search unit

130: second content search unit

140: user information management unit

141: provider DB 142: advertiser DB

143: propagator DB

150: purchase information management unit

160: central processing unit

161: operating software 200: provider computer

300: advertiser computer 400: propagator computer

### [Best Mode]

The above and other objects, features and other advantages of the present invention will be more clearly understood from the following detailed description, taken in conjunction with the accompanying drawings. Before the description of the present invention is given, it should be noted that the terms or words used in the present specification and claims are to be interpreted. as having meanings and concepts corresponding to the technical spirit of the present invention on the basis of the principle by which the inventor can suitably define the concept of terms to describe the invention thereof in the best way. Further, it should be noted that detailed descriptions may be omitted if it is determined that the detailed descriptions of related well-known functions and constructions would make the gist of the present invention unclear.

Hereinafter, embodiments of the present invention will be described in detail with reference to the attached drawings.

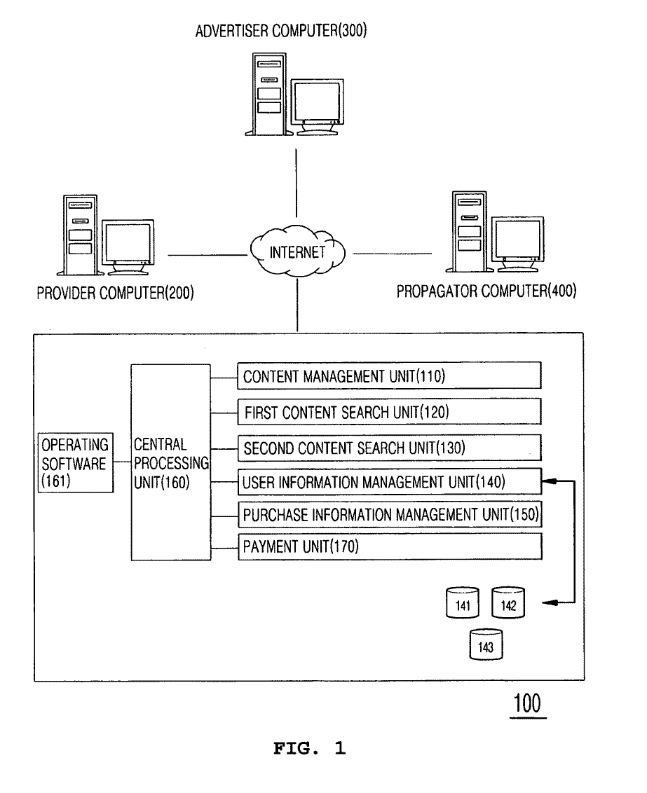

The construction of an Internet advertisement system based on the provision of content according to an embodiment of the present invention is described with reference to FIG. 1.

FIG. 1 is a conceptual diagram showing the overall construction of an Internet advertisement system based on the provision of content (hereinafter referred to as an ‘advertisement system’) according to an embodiment of the present invention. As shown in the drawing, the advertisement system includes an operator server 100, a content provider computer (hereinafter referred to as a ‘provider computer’) 200, an advertiser computer 300, and a content propagator computer (hereinafter referred to as a ‘propagator computer’) 400.

As shown in FIG. 1, the operator server 100 receives content from the provider computer, information about an advertisement website from the advertiser computer, and information about a web page to which unique HyperText Markup Language (HTML) code for content is attached from the propagator computer, thus providing an advertisement corresponding to content that is used. The operator server 100 includes a content management unit 110, a first content search unit 120, a second content search unit 130, a user information management unit 140, a purchase information management unit 150, and a central processing unit 160. In detail, the content management unit 110 functions to receive various types of content, including text, images, sound, moving images, games and applications from the provider computer 200, and to store and manage various types of content. In this case, respective content items can be configured to be packaged, and are assigned unique IDs and unique HTML codes. For reference, the unique HTML codes assigned to respective content items can be provided in any form, whether static HTML code or dynamic HTML code, in an actual web page, and may be any type of description code supporting a HyperText Transfer Protocol (HTTP) request. For example, the HTML code can be configured using an image tag, or an embed tag, used when a moving image, a flash object, etc. are intended to be included, and can be configured to have a dynamic form using Script code.

The first content search unit 120 functions to search for content stored in the content management unit in response to a request from the advertiser computer.

The second content search unit 130 functions to search for content stored in the content management unit in response to a request from the propagator computer. As described above, a unique ID is assigned to each content item, and a unique HTML code is also attached to the content item.

The user information management unit 140 functions to store and manage the personal information and account information of the provider, the advertiser, and the propagator, and to receive and manage information about the website of the advertiser and the web page of the propagator. The user information management unit 140 includes a provider DB 141 for receiving ‘provider information’, including personal information, such as the name and address of a content provider, and the bank account information of the content provider, from the provider computer 200, and managing the provider information, an advertiser DB 142 for receiving from the advertiser computer 300 both ‘advertiser information’, including personal information, such as the name and address of an advertiser, and account information of the advertiser, and information about a website desired to be advertised by the advertiser, and managing the advertiser information and the website information, and a propagator DB 143 for receiving from the propagator computer 400 ‘propagator information’, including personal information, such as the name and address of a content propagator, and account information of the propagator, HTML code for selected content, and information about the web page of the propagator, and storing and managing the propagator information, the HTML code, and the web page information.

The purchase information management unit 150 functions to receive the ‘advertiser information’ of the advertiser, who purchased content, from the advertiser computer 300, and to separately store and manage the advertiser information and purchased content when the advertiser purchases the content.

The central processing unit 160 executes the entire process by controlling the content management unit 110, the first content search unit 120, the second content search unit 130, the user information management unit 140, and the purchase information management unit 150 in a centrally controlled manner, and includes operating software 161 for allowing the designated web page of the advertisement system to exist in form of multiple frames, separating a content placing area (hereafter referred to as a ‘floating area’), and an advertiser's website placing area (hereafter referred to as a ‘background area’).

Further, the present invention is constructed to calculate fees incurred for the purchase of content by the advertiser, to pay the fees to the operator server, to calculate fees incurred for the use of content by the Internet user, and to pay the fees to the content provider or the propagator. The present invention may further include a payment unit 400 for calculating fees incurred for the purchase of content by the advertiser, and fees based on the frequency of exposure of an advertiser's site registered in content, interaction records and events that occur when content and the advertiser's website are used, and various evaluation factors, such as the user's responses (hereinafter referred to as ‘payment conditions’), and processes payment to the provider computer 200, the advertiser computer 300, and the propagator computer 400.

That is, the payment unit 400 can be configured such that, when the advertiser purchases content and registers an advertisement in the content, the payment unit pays fees, incurred for the purchase of the content and the registration of the advertisement, to the content provider, such that, when the Internet user uses the content, the payment unit calculates revenue obtained through the use of content, and pays the revenue to the content provider, and such that, when the registered advertisement is exposed in such a way that the Internet user visits the web page of the propagator and executes the HTML code attached to the web page to use the content, the payment unit calculates revenue obtained through the exposure of the advertisement and pays the calculated revenue to the content propagator. In this embodiment, the calculation of revenue is limited to the revenue obtained through the use of content, but the present invention is not limited to this embodiment, and the calculation of revenue can be variously set using a method of paying a fee promised when an advertisement is registered, etc.

The provider computer 200 functions to transmit or receive content and information about payment conditions related to the content to or from the operator server 100 over the Internet.

The advertiser computer 300 functions to transmit or receive information about a website desired to be advertised and payment conditions related to an advertisement to or from the operator server 100 over the Internet.

The propagator computer 400 functions to transmit or receive information about the web page of a propagator, HTML code, and payment conditions related to the use of content by typical Internet users to or from the operator server 100 over the Internet.

In this embodiment, each of the provider computer 200, the advertiser computer 300, and the propagator computer 400 is set to a communication-enabled computer device that includes a CPU having a Pentium or higher level, 64 Mb or higher Random-Access Memory (RAM), a hard disk, Compact Disk (CD) Read-Only Memory (ROM), an information input device having a mouse and a keyboard, an information output device having a monitor, a speaker, a printer, and a communication port, and a Windows 98 or higher Operating System (OS). Such a computer is configured to have an Internet browser capable of displaying web content, and to include a mobile phone, a Personal Digital Assistant (PDA), etc. enabling wireless Internet communication, as well as a personal computer, such as a desk-top computer and a notebook computer, but the computer of the present invention is not limited to this device.

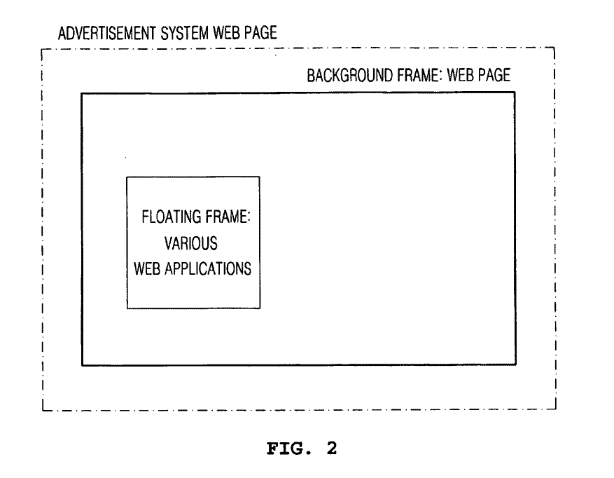

FIG. 2 is a diagram conceptually showing the screen configuration of the advertisement system, in which a user who uses the content of the advertisement system actually visits the page of the advertisement system. The page of the advertisement system has the unique ID of the content management unit as a parameter, and both the previously registered website and content of an advertiser are simultaneously displayed on the page using the unique ID. The page itself of the advertisement system functions only as a transparent frame, rather than representing specific content. For methods of configuring such a frame structure, a method using an iFrame is the most widely used method in actual implementation, and a frame structure, included in a web page, such as Google AdSense, uses this iFrame method. In the above-described frame, two internal frames are separately arranged in a background and a foreground. One is a background area frame, which actually occupies the entire screen area of the web browser of the Internet user and in which the advertisement site of the advertiser is loaded. The other is a foreground area frame, which is always shown in front of the background and which has a smaller size than the background so that the background is always shown. The foreground area frame has structural characteristics in that most types of online content generally have small sizes to occupy part of web pages. The foreground area frame is also called a floating frame due to the effect thereof, in which it seems to float over the background. In the foreground area frame, a dynamic web application is placed to include a static web page that is smaller than the background. In the floating frame, all web applications which are operable in the web browser and base programs operating in the browser (for example, Flash, JavaScript, etc.) can be run, so that various types of content can be used, and the area of the floating frame can be freely adjusted according to the circumstances. As indicated in the literal meaning of the name itself, the floating frame has a structure in which it freely floats over the background frame, so that the website of the advertiser is exposed as the background, thus guaranteeing a similar effect as if an advertisement website were actually visited while a user continues to use content. That is, in order for the user to use the content of the system to which the present invention is applied through such a structure, the present invention is constructed to enable desired content to be freely used in an advertisement website by placing content or a set of content items in the floating frame, which can float over the background frame, in the form of a web application while guaranteeing the effect of the advertisement by allowing the designated web page of the advertisement system to display two separate frames simultaneously, so as to allow for the advertiser's website to be exposed as the background while the content is displayed in the foreground. An example of implementation of this construction is described below with reference to an advertisement method, which will be described later.

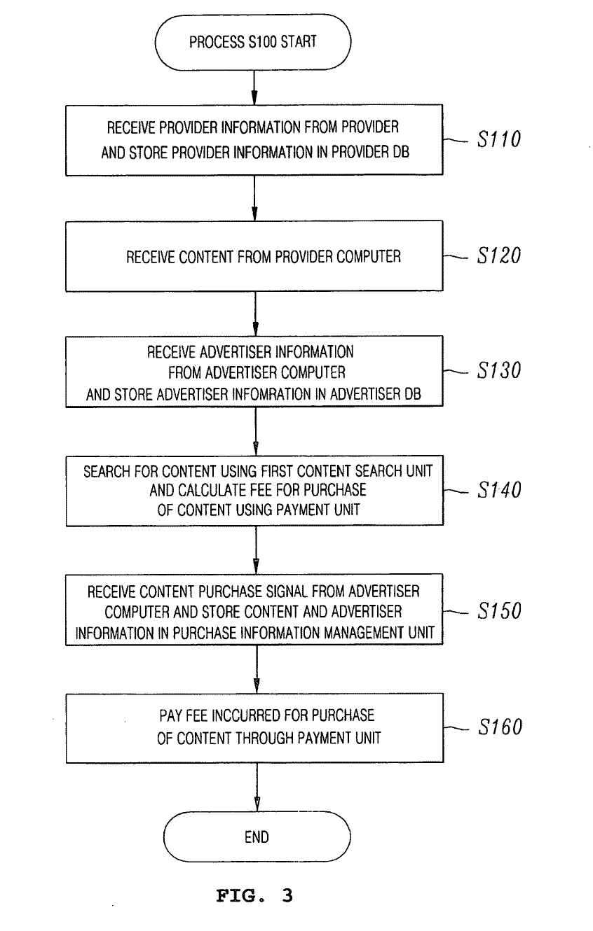

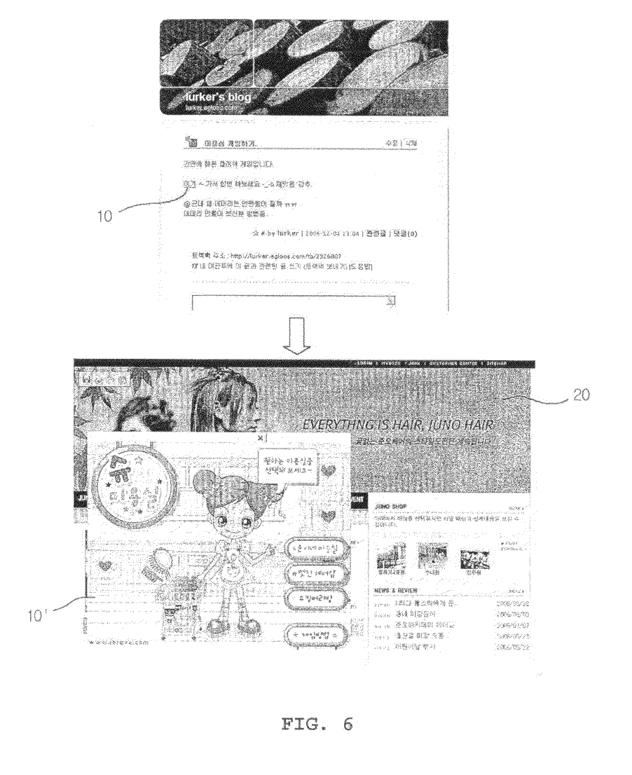

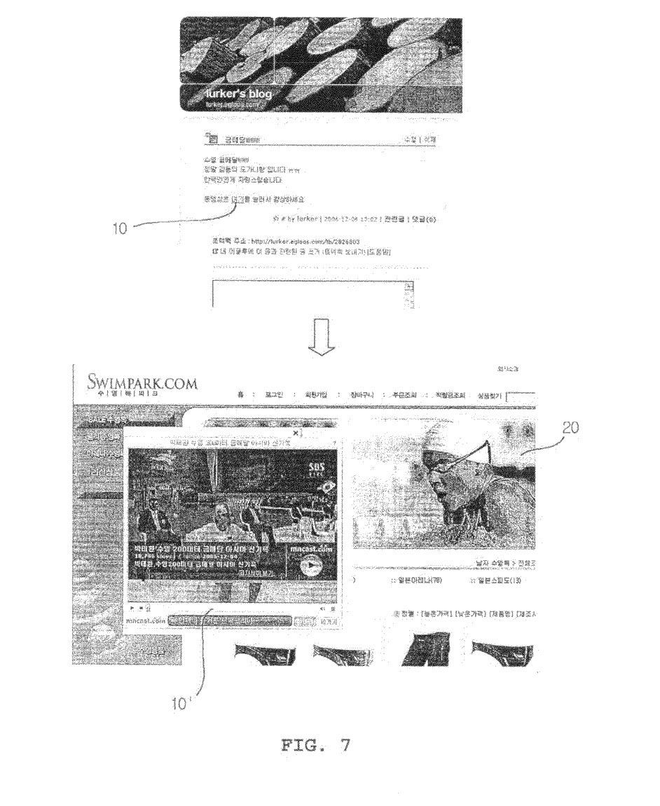

The flow of an Internet advertisement method according to an embodiment of the present invention using the above-described advertisement system is described with reference to FIGS. 3 to 7.

First, a process S100 in which the operator server 100 registers content and an advertisement according to an embodiment of the present invention is described below.

As shown in FIG. 3, the central processing unit 160 of the operator server 100 receives provider information, including personal information and bank account information, from the provider computer 200, and stores the provider information in the provider DB 141 of the user information management unit 140 at step S110.

The central processing unit 160 receives content from the provider computer 200, and stores the content in the content management unit 110 at step S120.

The central processing unit 160 receives advertiser information, including personal information and account information, from the advertiser computer 300, and stores the advertiser information in the advertiser DB 142 of the user information management unit 140 at step S130.

The central processing unit 160 searches for the content stored in the content management unit 110 using the first content search unit 120 in response to a request from the advertiser computer 300, provides the found content to the advertiser computer, calculates the fee for the purchase of content through the payment unit 170, and provides information about the fee at step S140.

When a corresponding content purchase signal is received from the advertiser computer 300, the central processing unit 160 stores the advertiser information and the corresponding content in the purchase information management unit 150 at step S150.

The central processing unit 160 is paid the fee, incurred for the purchase of the content by the advertiser computer 300, by the advertiser computer 300 through the payment unit 170 at step S160.

Meanwhile, a process S200 in which the operator server 100 receives information about the web page of the propagator, to which unique HTML code for content is attached, from the propagator computer 400, and provides content according to an embodiment of the present invention is described below.

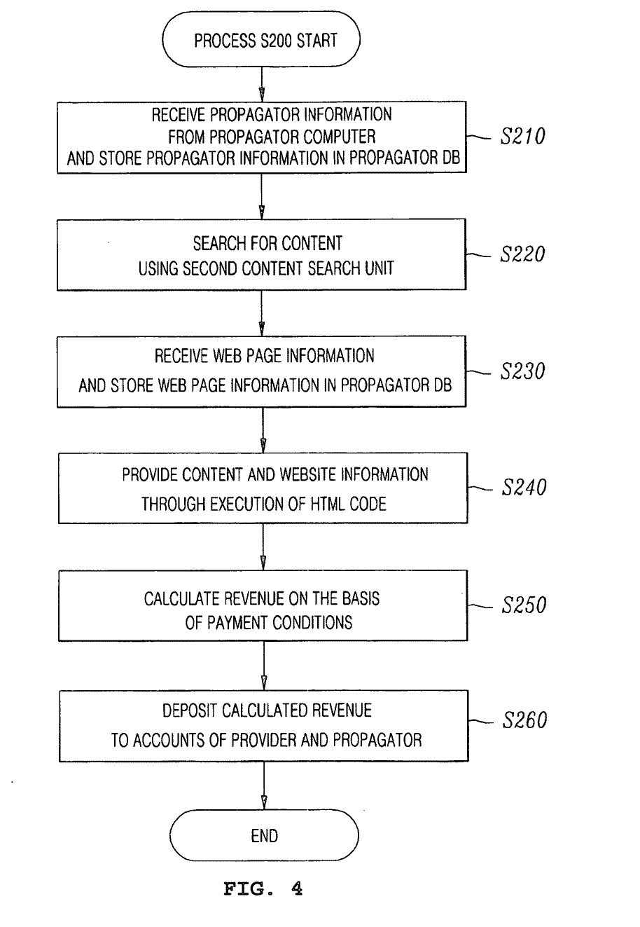

As shown in FIG. 4, the central processing unit 160 receives propagator information, including personal information and bank account information, from the propagator computer 400, and stores the propagator information in the propagator DB 143 of the user information management unit 140 at step S210.

The central processing unit 160 searches for content stored in the content management unit 110 using the second content search unit 130 in response to a request from the propagator computer 400, and provides the found content to the propagator computer at step S220.

The central processing unit 160 receives information about the web page, to which unique HTML code for content selected by the propagator is attached, from the propagator computer 400, and stores the web page information in the propagator DB 143 of the user management unit at step S230.

When a content execution signal is received from a typical Internet user computer (hereinafter referred to as a ‘typical computer’), the central processing unit 160 executes the unique HTML code for the content, and provides both content and an advertisement website corresponding to the HTML code.

The central processing unit 160 transmits both the corresponding content, stored in the content management unit 110 or the purchase information management unit 150, and the website information, stored in the advertiser DB 142, at step S240.

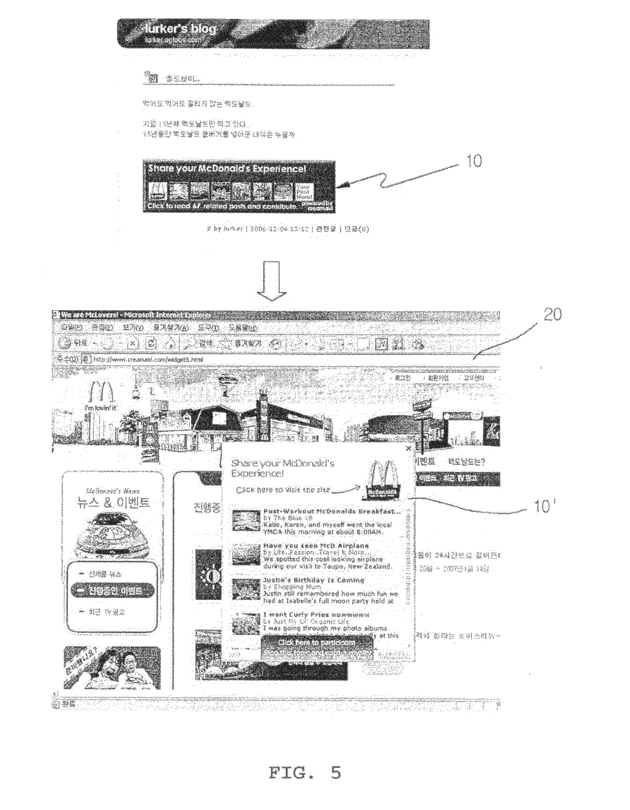

That is, as shown in FIGS. 5 to 7, when content 10 is displayed on the web page of the propagator and a typical Internet user clicks corresponding content, the advertisement website 20 of the advertiser is displayed in a background area, at the same time that content 10′ is provided in the floating area through the execution of the unique HTML code for the content.

Thereafter, the central processing unit 160 calculates revenue, obtained through the execution of the HTML code, through the payment unit 170 on the basis of payment conditions, such as the exposure of the advertisement, at step S250.

The central processing unit 160 deposits the calculated revenue to the bank accounts of the provider and the propagator at step S260.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, all suitable modifications, changes and equivalents should be interpreted as being included in the scope of the present invention.

### INDUSTRIAL APPLICABILITY

According to the present invention, there is an advantage in that, when Internet content to which the website of an advertiser is linked is used, the content is displayed together with the website of the advertiser, thus enabling the Internet user to use content according to his or her original intention, while having a similar effect as if the advertisement website were visited intentionally.

Further, according to the present invention, the effect of naturally visiting the website of an advertiser is realized through the use of content, thus ensuring relatively high advertising cost rate for the advertiser, and consequently guaranteeing high revenue corresponding to the advertising costs to the content provider.

Further, according to the present invention, there is an advantage in that a typical website user can attach content to his or her web page, and can be paid suitable revenue, attributable to a website visit-based advertising effect occurring whenever a person visiting the website uses the content.

Moreover, according to the present invention, there is an advantage in that a user attaches content made by other persons to his or her web page, so that an Internet user can become a voluntary content propagator, and the propagator can increase revenue according to the degree of use of the content by web page visitors, thus authorizing the copyright of other persons using a reasonable method, and providing Internet environments that enable content to be used according to an appropriate procedure.

1. An Internet advertisement system based on provision of content, comprising:
an operator server for receiving content from a provider computer, information about an advertiser's website from an advertiser computer, and a web page, to which unique HyperText Markup Language (HTML) code for the content is attached, from a propagator computer, thus providing an advertisement corresponding to content that is used;
the provider computer for transmitting or receiving the content and information about payment conditions to or from the operator server;
the advertiser computer for transmitting or receiving information about a website desired to be advertised and payment conditions related to an advertisement to or from the operator server; and
the propagator computer for transmitting or receiving information about the web ₚage of a propagator, the HTML code, and payment conditions related to use of content by a typical Internet user to or from the operator server.

2. The Internet advertisement system according to claim 1, wherein the operator server comprises:
a content management unit for receiving content from the provider computer, and storing and managing the content;
a first content search unit for searching for content stored in the content management unit in response to a request from the advertiser computer;
a second content search unit for searching for content stored in the content management unit in response to a request from the propagator computer;
a user information management unit for receiving information about a provider, information about an advertiser, and information about the propagator from the provider computer, the advertiser computer, and the propagator computer, respectively, storing and managing the received information, receiving information about the advertiser's website from the advertiser computer and information about the propagator's web page from the propagator computer, and managing the website information and the web page information;
a purchase information management unit for receiving information about an advertiser, who purchased content, from the advertiser computer, and storing and managing the advertiser information and the purchased content when the advertiser purchases the content; and
a central processing unit for executing an entire process by controlling the content management unit, the first content search unit, the second content search unit, the user information management unit, and the purchase information management unit in a centrally controlled manner, the central processing unit comprising operating software for going to a web page of the advertisement system, separating a floating area and an advertisement background area in the web page of the advertisement system, and enabling given content to be used in the advertiser's website.

3. The Internet advertisement system according to claim 2, wherein the user information management unit comprises:
a provider Database (DB) for receiving the provider information from the provider computer and managing the provider information;
an advertiser DB for receiving the advertiser information and the information about the website desired to be advertised by the advertiser from the advertiser computer, and managing the advertiser information and the website information; and
a propagator DB for receiving the propagator information and the information about the web page, to which unique HTML code for content selected by the propagator is attached, from the propagator computer, and storing and managing the propagator information and the web page information.

4. The Internet advertisement system according to claim 1, further comprising a payment unit for calculating a fee incurred for purchase of the content on a basis of the payment conditions.

5. The Internet advertisement system according to claim 1, wherein the content has any one form of text, images, sound, moving images, games, and applications.

6. The Internet advertisement system according to claim 1, wherein the content is assigned a unique Identification (ID) and unique HTML code.

7. An Internet advertisement method based on provision of content in a method of registering an advertisement and content using an Internet advertisement system based on provision of content, the Internet advertisement system including an operator server, a provider computer, an advertiser computer and a propagator computer, comprising the steps of:
(a) the operator server receiving information about a provider from the provider computer and storing the provider information;
(b) the operator server receiving content from the provider computer and storing the content;
(c) the operator server receiving information about an advertiser from the advertiser computer and storing the advertiser information;
(d) the operator server providing the content to the advertiser computer, calculating a fee incurred for purchase of the content, and providing information about the fee to the advertiser computer in response to a request from the advertiser computer; and
(e) the operator server storing the advertiser information and corresponding content when a corresponding content purchase signal is received from the advertiser computer.

8. The Internet advertisement method according to claim 7, further comprising the step of (f), after step (e), the operator server being paid a fee, incurred for purchase of the content, by the advertiser computer.

9. An Internet advertisement method based on provision of content in a method of providing content using an Internet advertisement system based on provision of content, the Internet advertisement system including an operator server, a provider computer, an advertiser computer, and a propagator computer, comprising the steps of:
(g) the operator server receiving information about a propagator from the propagator computer and storing the propagator information;
(h) the operator server searching for content in response to a request from the propagator computer and providing the content to the propagator computer;
(i) the operator server receiving information about a web page, to which unique HTML code for content, selected by the propagator, is attached, from the propagator computer, and storing the web page information;
(j) the operator server executing the HTML code for the content, providing content corresponding to the HTML code to a floating area, and exposing an advertiser's website to a background area when a content execution signal is received from a typical computer; and
(k) the operator server calculating revenue obtained through execution of the HTML code on a basis of payment conditions.

10. The Internet advertisement method according to claim 9, further comprising the step of (l), after step (k), the operator server calculating revenue and depositing the revenue to accounts of both a provider and the propagator.
